(19) United States
(12) Patent Application Publication
(10) Pub. No.: US 2025/0172023 A1
(43) Pub. Date: May 29, 2025

(54) Device for Generating Opening Signals

(71) Applicant: Illinois Tool Works Inc., Glenview, IL (US)

(72) Inventors: Fritz GÖBEL, Würzburg (DE); Andreas RUDOLF, Eibelstadt (DE)

(21) Appl. No.: 18/944,680

(22) Filed: Nov. 12, 2024

(30) Foreign Application Priority Data
Nov. 24, 2023 (DE) 10 2023 132 898.0

(51) Int. Cl. E05B 83/34; B60K 15/05; B60L 53/14; E05B 47/00

(52) U.S. Cl. CPC E05B 83/34; B60K 15/05; B60L 53/14; E05B 47/0001; E05B 2047/0072

(57) ABSTRACT

The present disclosure relates to a device for generating signals. The device includes: a signal module with a housing (112) with a switch region (121); at least one switch (120) that is connected to the switch region of the housing; a sealing element (132) to protect the housing from environmental influences. The switch (120) includes an actuator device (122). At least a portion of the actuator device (122) extends through the sealing element (132).

### RELATED APPLICATIONS

The present application claims the benefit of German Patent Application No. 10 2023 132 898.0, filed Nov. 24, 2023, titled “Device for Generating Opening Signals,” the contents of which are hereby incorporated by reference.

### BACKGROUND

Vehicles with a hybrid or electromotive drive usually have one battery or traction battery, which, for example in the case of plug-in hybrid electric vehicle (PHEVs) or battery electric vehicles (BEVs), can be charged via an electrical charging port that is accessible from the outside on the vehicle body, and is typically a charging port, by connecting to an electrical charging station, for example, or a conventional external electrical port.

The charging port is usually arranged in a charging well of the vehicle body, which is covered or closed by a charging flap or a charging closure element. A mechanism that cooperates with the charging flap or charging closure element selectively allows the charging well to be opened and closed or the charging flap or charging closure element to be flipped open and closed in relation to the charging well, and thus allows access to the charging port.

In vehicles with a combustion-based drive, a fuel tank is supplied with fuel via a refueling filler-neck, which is accessible from the outside by connection to a fuel pump or a refueling nozzle, for example. Corresponding to the charging port, the refueling nozzle is usually arranged in a refueling well assigned to the vehicle body, which is covered or closed by a refueling flap or a refueling closure element. Here, too, a mechanism that cooperates with the refueling flap or refueling closure element selectively allows the refueling well to be opened and closed or the refueling flap or refueling closure element to be flipped open and closed in relation to the refueling well, and thus allows access to the refueling filler-neck.

### SUMMARY

The present disclosure relates generally to a device for generating opening signals, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a partial perspective view of a device according to a first aspect of the present disclosure on a corresponding charging well.

FIG. 2 illustrates a sectional view through the device according to FIG. 1 in the rest position.

FIG. 3 illustrates a sectional view through the device according to FIG. 1 in the actuating position.

FIG. 4 illustrates is a schematic, perspective view of the device according to the disclosure in FIG. 1 during installation in a charging well during a first installation step.

FIG. 5 illustrates a schematic, perspective view of the device according to FIG. 1 during a second installation step.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a device for generating signals, in particular signals for opening vehicle doors or flaps. A further aspect relates to a charging, refueling, or service assembly for a vehicle with such a device for generating signals.

The terms “refueling flap” and “refueling well” as used herein are not understood to mean only the components associated with refueling or the components necessary for refilling a fuel tank. Rather, these terms are also intended to include components for a tank for receiving other resources, for example AdBlue or urea, or an additive such as water. Accordingly, the disclosure also relates to actuating mechanisms for actuating service flaps associated with a filling system for a resource or additive fueling, in particular a fuel, AdBlue, or water tank.

In the prior art, there is a fundamental need for charging, refueling, or service flaps that are intuitively and reliably actuatable. Also, the charging, refueling, or service flaps must minimally affect the exterior appearance of the vehicle.

Based on this, the problem addressed by the disclosure is to specify a charging, refueling, or service flap which is easy to actuate and has a substantially identical outer surface to the vehicle outer shell.

This underlying problem of the disclosure is solved in particular by the subject-matter of the independent claim 1, wherein advantageous further developments of the charging, refueling, or service flap according to the disclosure are specified in the dependent claims.

Accordingly, the present disclosure relates to a device for generating signals, in particular signals for opening vehicle doors or flaps, wherein the device comprises the following: a signal module which has a housing with a switch region; at least one switch, in particular a microswitch, which is connected, in particular releasably connected, to the switch region of the housing; a sealing element which is designed to protect the housing from environmental influences, wherein the switch has an actuator device, and wherein at least a portion of the actuator device extends through the sealing element.

The device for generating signals according to the disclosure is a module which can be fitted partly in the dry region and partly in the wet region of a vehicle body. The parts of the signal module located in the dry region are protected from environmental influences by the sealing element. The actuator device extends through the sealing element and can therefore be used to detect movements in the wet region and generate the corresponding signal.

According to a further aspect, the device has an actuating flap which is arranged pivotably relative to the housing and is designed to transmit a movement of an operating element 116 to the actuator device of the switch, so that the at least one switch is activated by moving the operating element. In other words, the actuating flap is arranged between an operating element and the actuator device of the switch when the device is installed. The actuating flap can, for example, be mounted with a sub-region of the housing of the signal module so that a movement of the actuating flap relative to the housing and thus relative to the actuator device of the switch can be precisely defined. This means that the movement of the actuating flap can be used repeatedly to activate the switch. The actuating flap simultaneously represents a relatively large actuating surface for the operating element, meaning that tolerances are easily compensated when installing the module compared to the operating element.

Finally, as will be explained in more detail later, a small movement of the operating element can be amplified by the pivoting actuating flap in such a way that this leads to a larger pivoting movement of the actuating flap, which is sufficient to activate the actuator device of the switch, for example to press it in. Finally, the movement of the actuating flap can achieve an essentially vertical application of force to the actuator device of the switch. This has the advantage that possible shear forces or lateral friction and the associated wear of the actuator device can be prevented, regardless of the direction of movement of the corresponding operating element.

According to a further aspect, the housing has at least one extension, in particular a pin, which extends from the switch region of the housing in the direction of the sealing element, wherein the extension is designed to define a pivot bearing of the actuating flap. According to this aspect, not only the actuator device extends into the wet region of the vehicle body. The extension described here also extends through a sealing element into the wet region and serves to precisely define the position of the actuating flap in relation to the actuator device of the switch. Thus, the extension is used for positioning on the one hand, and as a pivot bearing for the actuating flap on the other.

According to a further aspect, the device has electrical contacts which are connected, in particular detachably, to the at least one switch and extend from the switch region at least partially into a plug-in region of the housing, wherein the electrical contacts are designed to establish an electrical contact with a plug on the vehicle side for transmitting an electrical signal. The integral plug-in region of the housing is used to receive a vehicle-side plug, which only has to be plugged into the plug-in region to connect the device to a corresponding control device in the vehicle. The electrical contacts connect the contacts of the switch to the plug-in region and can also serve as terminals for the plug-in region.

In another aspect, the plug-in region has a socket for receiving the plug on the vehicle side, in particular the plug of a control unit or of an electric actuator. The plug-in region of this aspect is thus designed as a socket into which the ends of the electrical contacts extend. The device is therefore not only used to receive the switch and to establish a reliable connection with the electrical contacts. Rather, it also has a socket for receiving a corresponding electrical contact plug from the electric drive. Once the device has been installed, all that remains to be done is to insert the plug of the electric drive into the socket of the module to create a reliable electrical connection between the switch and the drive/control device of the drive.

According to a further aspect, the electrical contacts have a first elastic end which is in contact with the at least one switch, wherein the first elastic end of the electrical contacts is biased against each of the contacts of the at least one switch. This ensures a reliable connection between the electrical contacts and the contacts of the switch, as the electrical contacts are biased against the contacts of the switch. However, it is not necessary to bias the contacts against the microswitch when manufacturing the module. Instead, the electrical contacts can be quickly and easily anchored to the module housing, wherein the bias is achieved automatically by connecting the housing of the signal module to the vehicle body.

A further aspect of the present disclosure relates to a charging, refueling, or service assembly for a vehicle, comprising the following: a charging, refueling, or service well that is or can be received on a housing of the vehicle, in particular a body element of the vehicle; a charging, refueling, or service flap, which can be moved reversibly by an actuator between a closed position and an open position relative to the charging, refueling, or service well; and a device according to one of the claims 1 through 5, wherein the device is arranged in the charging, refueling, or service well in such a way that pressing the charging, refueling, or service flap in the closed position leads to the actuation of the actuator device of the switch.

In another aspect, the charging well has a wall which separates a wet region from a dry region of the vehicle, wherein at least part of the actuator device extends through the wall. In particular, the sealing element of the device can be arranged in such a way that it seals these gaps/leaks between the wall and the actuator device, so that no foreign bodies or water can penetrate into the device's housing between the wall and the actuator device.

In another aspect, the at least one extension of the housing extends through the wall. As mentioned above, the extension is used in particular to position the actuating flap in relation to the signaling module. A second sealing element may be provided to seal any gaps between the extension and the wall of the charging well, so that no foreign bodies or water can enter the dry region either.

According to a further aspect, the charging, refueling, or service well has an actuating housing which is connected to the wall in the wet region and is designed to receive the actuator device of the switch. The operating housing, for example, can be designed in two parts. In this way, a first region of the actuating housing designed as a pocket can be formed in one piece with the wall, wherein a second sub-region of the actuating housing is designed as a cover which covers the open part of the pocket when the signaling module and the actuating flap are arranged ready inside the pocket. The actuating housing further improves the protection of the dry region behind the wall against possible environmental influences, especially water ingress. The actuating housing also provides the actuating flap with essential protection against environmental influences.

The actuating flap can be pivotally received in the actuating housing, wherein a pivot axis of the actuating flap is mounted between the at least one extension of the housing and an inner wall of the actuating housing. A pivoting movement of the actuating flap can thus be precisely defined by the actuating housing and the at least one extension. At the same time, the pivot axis is effectively protected from contamination by the actuating housing.

In a further aspect, the charging, refueling, or service flap is connected to the charging, refueling, or service well such that it can be moved by means of at least one joint, wherein the joint is connected to the actuator device in such a way that movement of the joint in at least one direction leads to activation of the actuator device.

According to a further aspect, the at least one joint is designed such that the charging, refueling, or service flap can be pushed onto the charging, refueling, or service well in the closed position in order to move the joint in the at least one direction.

Another aspect of the present disclosure relates to a vehicle with a charging, refueling, or service assembly as described above.

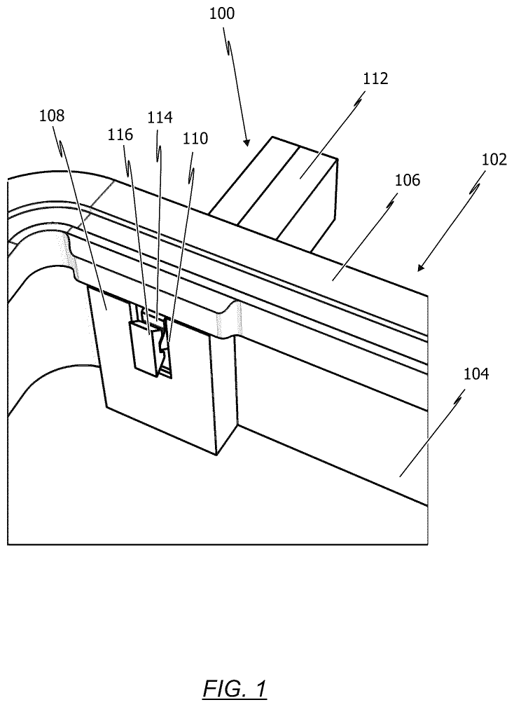

FIG. 1 is a schematic, perspective view of a device 100 according to one aspect of the present disclosure attached to a charging, refueling, or service well 102. In the following, particular reference is made to a charging well 102, although this is not restrictive for the scope of protection of the present disclosure, because, fundamentally, the device can be attached to any part of a vehicle body that separates a wet region from a dry region. For example, the device can also be used to be attached to the back of a door lever in order to detect the actuation of the door lever via the actuator device of the switch. Accordingly, the disclosure is not limited to the assembly of the device for generating signals at a specific region of the vehicle body.

The charging well 102, shown schematically in FIG. 1, has a well body 104 that is designed to receive the charging ports and to enable a connection to be made to corresponding charging plugs of a charging station. The figures shown here do not depict such charging ports for the sake of simplicity. However, it should be noted that the region of the charging port 104 shown here is classified as a wet region, since it is not protected from environmental influences at least during the charging process, i.e., when the charging flap is open. The wall of the charging well 104 is designed in such a way that moisture in particular cannot penetrate into the interior of the vehicle body.

An adapter frame 106 is arranged at an upper end region of the well body 104. The adapter frame 106 is used in particular to adapt a universal well body 104 to the shape and dimensions of a desired charging flap (not shown here). In other words, the adapter frame 106 covers the well body 104 in the edge region and seals it together with the charging flap when the charging flap is closed.

As will be explained in more detail later, the adapter frame 106 can be used at the same time to cover an actuating housing 108, which is part of the well body 104.

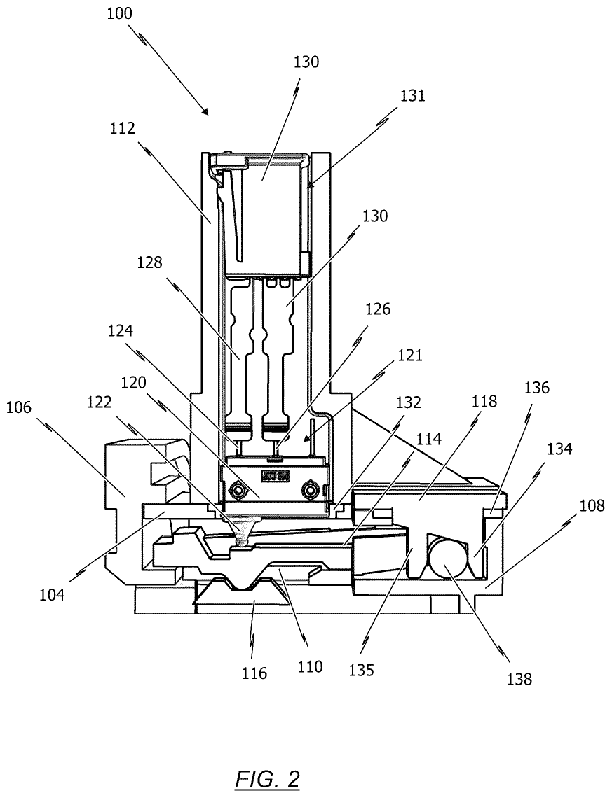

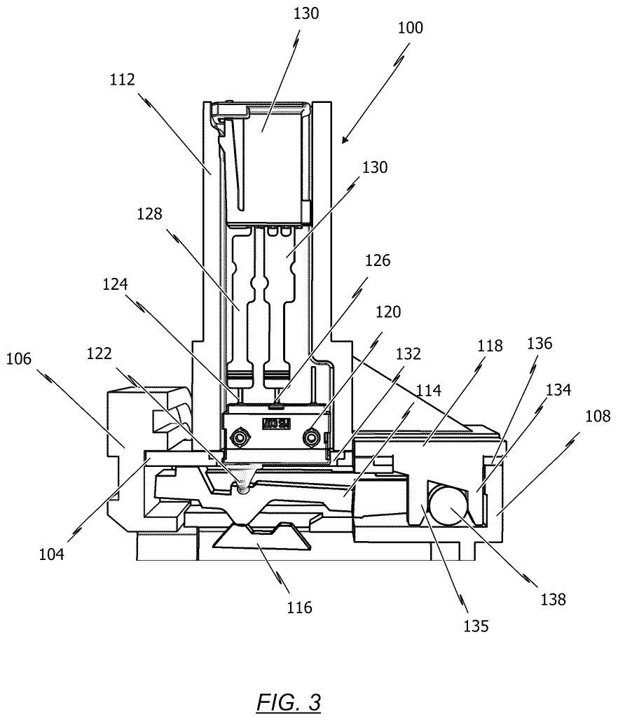

A device 100 according to a first aspect of the present disclosure is rear-mounted, that is, attached to a rear wall of the well body 104. The attachment of the device 100 to the rear wall of the well body 104 can be seen in particular in FIGS. 2 and 3. FIGS. 2 and 3 show a sectional view through the aspect of the device 100 shown in FIG. 1. The sectional view in FIGS. 2 and 3 is shown in two different planes to illustrate, on the one hand, the passage of the actuator device 122 through the wall of the well body 104 and, on the other hand, the passage of the extensions 134, 135.

As shown in FIGS. 2 and 3, an enclosure 112 of the device 100 is substantially connected to the rear wall of the well body 104. The enclosure 112 can, for example, be glued, welded, or clipped to the rear wall. The majority of the 112 housing is therefore located in the dry region of the vehicle body, which extends behind the rear wall of the well body 104.

The device 100 has a housing 112 with a switch region 121 and a plug-in region 131. The housing can, for example, be designed as an injection-molded plastic body.

A switch 120, in particular a microswitch, is detachably connected to the switch region 121. For this purpose, the housing 112 can have one or more receiving openings that serve to align the switch 120 with the housing 112. The switch 120 can, for example, be inserted into such openings via snap-fits in order to be detachably connected to the housing. As will be described in more detail below, the switch 108 is designed in particular as a pushbutton with an actuator device 122. In particular, the switch is arranged in the housing 112 such that at least the actuator device 122 extends out of the housing 112. In other words, the actuator device 122 protrudes from the housing 112.

The device 100 may also include a first and a second electrical contact 128, 130. The electrical contacts 128, 130 each have a first end and an opposite second end. At the first ends, the electrical contacts 128, 130 are connected to corresponding contacts, such as contact pins 124, 126, of the switch 104. In particular, the first electrical contact 128 is connected at its first end to a first contact pin 126 of the switch 120. The second electrical contact 130 is connected via its first end to a second electrical contact pin 126 of the switch 120.

The second ends of the electrical contacts 128, 130 extend into a plug-in region 131 of the housing 112. The connection region 131 is used in particular to receive a corresponding plug for the power supply of an electric drive or for supplying any other consumer. For example, a plug of this type can be inserted into the plug-in region 131 and pushed onto the second ends of the electrical contacts 128, 130. In other words, the electrical contacts 128, 130 serve as an adapter between the terminals/contact pins 124, 126 of the switch 120 and a plug in the vehicle.

In the aspect shown here, a socket 130 is arranged in the plug-in region 131 of the housing 112. The electrical contacts 128, 130 of the device 100 extend into the socket 130, which is adapted to the shape and dimensions of the plug to be connected. The device 100 enables a quick and easy installation of an electrical switch at any point on the vehicle body. The switch can be electrically connected to a control device of the vehicle by simply inserting the plug into socket 130. It is therefore no longer necessary to solder the switch in a confined space with the control device.

In alternative aspects (not shown), the device does not have the electrical contacts 128, 130. Instead of the electrical contacts, it is also conceivable to connect the contact pins 124, 126 of the switch 120 to the control device/actuator via cables. The cables can either be routed directly to a control device or connected to appropriate connectors/terminals to transmit the signal to the control device/actuator.

Returning to switch 120, it should be noted that this is a pushbutton designed as a microswitch, which has an actuator device 122 for activating the switch. The actuator device 122 may, for example, be biased into the position shown in FIG. 2. For this purpose, a resetting element (not shown), for example a flat spring, is provided within the switch 120.

In the rest positions and actuating positions shown in FIGS. 2 and 3, at least the actuator device 122 of the switch 120 extends through the wall of the well body 104 into the wet region of the charging well. For this purpose, a first sealing element 132 is provided, which seals a corresponding opening in the wall of the well body 104 opposite the switch 120, that is, in particular, opposite the actuator device 122. The sealing element 132 can be any elastic seal. Accordingly, only the actuator device of switch 120 is located in the wet region, wherein the remaining parts of switch 120 and also of device 100 are arranged in the dry region and thus protected from environmental influences such as moisture.

In the aspect shown here, the actuator device 122 extends into an actuating housing 108, which is arranged in the wet region of the well body 104. In the aspect shown here, the actuating housing 108 is formed in two parts, wherein a first part is formed in one piece with the wall of the well body 104. A second part is formed by the adapter frame 106. The first region is designed in particular as a pocket, which is used to receive the actuator device 122 and an actuating flap 114. The actuating housing 108 protects the actuator device 122 and the actuating flap 114 from moisture and other environmental influences. However, it should be mentioned that it is still possible for moisture or dirt to enter the actuating housing 108 via an actuating opening 110. In other words, the inside of the actuating housing is not fully protected against environmental influences.

The actuating flap 114 is pivotally mounted within the actuating housing 108. In particular, the actuating flap 114 can be pivoted between the rest position shown in FIG. 2 and the actuating position shown in FIG. 3. The actuating flap 114 is biased in the rest position shown in FIG. 2.

In the rest position, the actuating flap 114 is not in contact with the actuator device 122 of the switch 120. Thus, the switch 120 is not activated in the rest position of the actuating flap 114. When the actuating flap 114 is moved from the rest position shown in FIG. 2 to the actuating position shown in FIG. 3, the actuating flap 114 is pivoted about the pivot axis 138 (here clockwise) towards the actuator device 122. The switch 120 is activated by pressing the actuator device 122, whereby an electrical signal is generated, which can be transmitted via the electrical contacts 128, 130 to a corresponding control device or an actuator for controlling the charging flap (not shown).

A pivoting movement of the actuating flap 114 is caused in particular by an operating element 116, which is shown only schematically in the aspects illustrated here. The operating element 116 is arranged on a side of the actuating flap 114 that is opposite the actuator device 122 of the switch 120. The actuator device 116 can be a means of the most diverse designs. In the example shown here, the operating element 116 could, for example, be part of the kinematics of the charging flap.

For example, the kinematics may involve joints that connect the charging flap to the charging well 102. The joints can be designed in such a way that they allow a certain tolerance of movement when the flap is pushed in the direction of the charging well when the charging flap is closed. In other words, the joints allow the vehicle user to push the charging flap in slightly even when it is closed, so that a relative movement of the operating element 116 (for example, a part of the flap joint) with respect to the actuating flap 114 is achieved. For example, the relative movement may be the translational movement of the operating element 116 with respect to the actuating flap 114, as schematically shown in FIGS. 2 and 3. The operating element 116 is arranged opposite the actuating flap in such a way that the relative movement caused by pressing the flap causes the operating element 116 to come into contact with the actuating flap 114 and to pivot it towards the actuator device 122.

It should be mentioned again at this point that the operating element 116 can be any element that is located in the wet region of the vehicle body and can be moved from the outside. The other, non-illustrated aspects may, for example, involve a part of the door lever that can be pressed in, for example, to generate a locking signal for the vehicle door lock.

As already indicated above, the actuating flap 114 is arranged so that it can be pivoted within the actuating housing 108 of the charging well 102. In order to be able to precisely define the pivoting movement of the actuating flap 114 with respect to the actuator device 122, the device 100 has extensions 134, 135, which also extend from the dry region into the wet region. The extensions 134, 135 shown in FIGS. 2 and 3 are designed as pins that extend into the interior of the actuating housing 108. In the aspect shown here, a second opening is provided for this purpose in the wall of the well body 104. A second sealing element 136 is used to seal the opening of the well body 104 against the extension, in order to effectively prevent moisture from entering via the second opening.

The extensions 134, 135, in particular together with the actuating housing 108, define the position of the pivot axis 138 of the actuating flap 114 within the actuating housing 108. Thus, the position of the actuating flap 114 relative to the switch or the actuator device 122 is also defined by the extensions 134, 135. This prevents the actuating flap from slipping within the actuating housing 118.

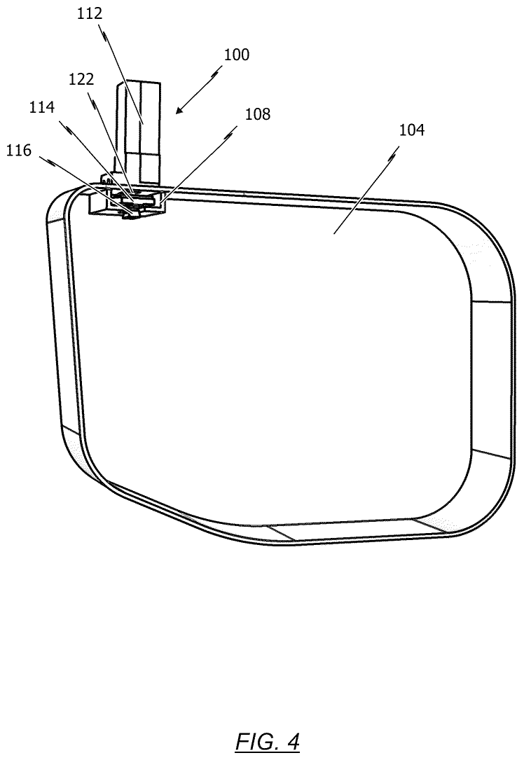

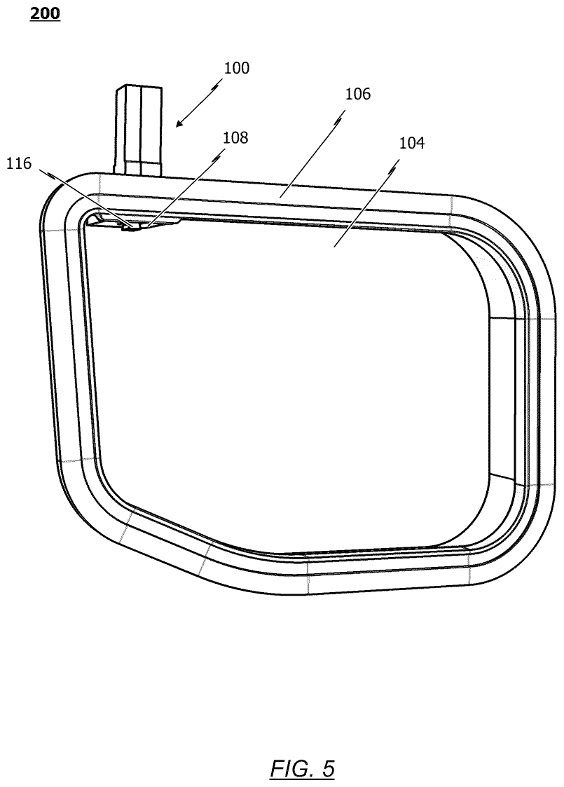

FIGS. 4 and 5 show the installation of the device according to the present disclosure in an exemplary charging assembly according to FIG. 1. In particular, FIG. 4 shows the well body 104 with the actuating housing 108 arranged in the wet region. The operating housing 108 is designed here in particular as a pocket which, on the upper side shown here, has an opening into which the actuating flap 114 can initially be inserted. After inserting the actuating flap 118, the housing 112 of the device 100 is attached to the rear wall of the well body 104. The actuator device 122 and the extensions 134, 135 shown in FIGS. 2 and 3 extend into the interior of the actuating housing 108 and fix the actuating flap 114 in the desired position.

FIG. 5 shows a further installation step in which the adapter frame 106 is attached to the edge region of the well body 104. The adapter element 106 of the present disclosure has a shoulder which serves to cover the above-mentioned opening for inserting the actuating flap 114 in order to protect it as far as possible from environmental influences.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A device (100) for generating signals for opening vehicle doors or flaps, wherein the device (100) has the following:
a signaling module comprising a housing (112) with a switch region (121);
at least one switch (120) that is detachably connected to the switch region (121) of the housing; and
a sealing element (132) designed to protect the housing (112) from environmental influences,
wherein the switch (120) includes an actuator device (122), and wherein at least a portion of the actuator device (122) extends through the sealing element (132).

2. The device (100) according to claim 1,
wherein the module (100) comprises an actuating flap (114) that is pivotally mounted relative to the housing (112) and is configured to transmit a movement of an operating element to the at least one switch (120) so that the at least one switch (120) is activated by moving the operating element.

3. The device (100) according to claim 2,
wherein the housing (112) has at least one extension (134, 135) that extends from the switch region of the housing essentially parallel to the actuator device (122), and wherein the extension (134, 135) is designed to define a pivot bearing of the actuating flap (114).

4. The device (100) according to claim 1,
wherein the device has electrical contacts (128, 130) which are connected releasably to the at least one switch (120) and extend from the switch region (121) at least partially into a plug-in region (131) of the housing (112), wherein the electrical contacts are designed to make electrical contact with a plug on the vehicle side for transmitting an electrical signal.

5. The device (100) according to claim 4,
wherein the plug-in region (131) has a socket for receiving a plug of a control unit or of an electric actuator.

6. The device (100) according to claim 4,
wherein the electrical contacts have a first, elastic end which is in contact with the at least one switch (120), and wherein the first, elastic end of the electrical contacts is respectively biased against one of the contacts of the at least one switch (120).

7. A charging, refueling, or service assembly for a vehicle, comprising the following:
a charging, refueling, or service well that is or can be received on a housing of a body element of the vehicle;
a charging, refueling, or service flap, which can be moved reversibly by an actuator between a closed position and an open position relative to the charging, refueling, or service well; and
the device according to claim 1, wherein the device is arranged in the charging, refueling, or service well in such a way that pressing the charging, refueling, or service flap in the closed position leads to the actuation of the actuator device (122) of the switch (120).

8. The charging, refueling, or service assembly according to claim 7,
wherein the charging, refueling, or service well has a wall which separates a wet region from a dry region of the vehicle, and wherein at least part of the actuator device (122) extends through the wall.

9. The charging, refueling, or service assembly according to claim 8,
wherein at least one extension (134, 135) of the housing (112) extends through the wall.

10. The charging, refueling, or service assembly according to claim 8,
wherein the charging, refueling, or service well has an actuating housing (108) which is connected to the wall in the wet region and is designed to receive the actuator device (122) of the switch (120).

11. The charging, refueling, or service assembly according to claim 10,
wherein an actuating flap (114) is pivotally received in the actuating housing (108).

12. The charging, refueling, or service assembly according to claim 11,
wherein a pivot axis of the actuating flap (114) is mounted between the at least one extension (134, 135) of the housing and an inner wall of the actuating housing (108).

13. The charging, refueling, or service assembly according to claim 10,
wherein the actuating housing (108) comprises a pocket and a cover releasably connected to the pocket.

14. The charging, refueling, or service assembly according to claim 7,
wherein the charging, refueling, or service flap is connected to the charging, refueling, or service well by at least one joint such that it can be moved, wherein the at least one joint is connected to the actuator device (122) in such a way that a movement of the at least one joint in at least one direction leads to activation of the actuator device (122).

15. The charging, refueling, or service assembly according to claim 14,
wherein the at least one joint is configured such that the charging, refueling, or service flap can be pushed onto the charging, refueling, or service well in the closed position in order to move the joint in the at least one direction.

16. The device (100) according to claim 1, wherein the at least one switch (120) is a microswitch (120).

17. A vehicle with a charging, refueling, or service assembly according to claim 7.
